(19) United States
(12) Patent Application Publication
(10) Pub. No.: US 2013/0299378 A1
(43) Pub. Date: Nov. 14, 2013

(54) Strengthening Glass Containers

(71) Applicants: Pramod K. Sharma, Ann Arbor, MI (US); Carol A. Click, Corning, NY (US)

(72) Inventors: Pramod K. Sharma, Ann Arbor, MI (US); Carol A. Click, Corning, NY (US)

(21) Appl. No.: 13/467,183

(22) Filed: May 9, 2012

(51) Int. Cl. C03C 17/30; B65D 1/40

(52) U.S. Cl. 206/524.3; 65/30.1; 65/17.2; 206/524.6

(57) ABSTRACT

A glass container and related methods of manufacturing a glass container. A solution having a composition including a silane, a solvent, a catalyst, and water, is applied to an exterior glass surface of the glass container, at a temperature between 40 and 60 degrees Celsius, such that the solution at least partially fills the surface imperfections. The glass container is heated at a temperature greater than 500 degrees Celsius to produce Si—O—Si bonds with the exterior glass surface of the glass container to result in a coating having between 10% and 20% silicate-based material by weight.

The present disclosure is directed to glass containers, and coating processes for glass containers including methods and materials for coating glass containers (e.g., glass bottles and jars).

### BACKGROUND AND SUMMARY OF THE DISCLOSURE

Various processes have been developed to apply coatings to glass containers for different purposes, including glass strengthening for damage prevention and fragment retention. For example, U.S. Pat. No. 3,522,075 discloses a process for coating a glass container in which the glass container is formed, coated with a layer of metal oxide such as tin oxide, cooled through a lehr, and then coated with an organopolysiloxane resin-based material over the metal oxide layer. In another example, U.S. Pat. No. 3,853,673 discloses a method of strengthening a glass article by, for example, applying to a surface of the article a clear solution of a soluble, further hydrolyzable metallosiloxane, and maintaining the glass article at an elevated temperature sufficiently high to convert the metallosiloxane to a heat-treated polymetallosiloxane gel structure. In a further example, U.S. Pat. No. 3,912,100 discloses a method of making a glass container by heating the glass container and applying a polyurethane powder spray to the glass container.

A general object of the present disclosure, in accordance with one aspect of the disclosure, is to provide an improved method of increasing strength of glass containers.

The present disclosure embodies a number of aspects that can be implemented separately from or in combination with each other.

A method of tilling surface imperfections in an exterior glass surface of a glass container in accordance with one aspect of the disclosure includes the steps of (a) providing a solution having a composition including a silane, a solvent, a catalyst, and water; (b) applying the solution provided in step (a) to the exterior glass surface of the glass container, at a temperature between 40 and 60 degrees Celsius, such that the solution at least partially fills the surface imperfections; and then (c) heating the glass container at a temperature greater than 500 degrees Celsius to produce Si—O—Si bonds with the exterior glass surface of the glass container to result in a coating having between 10% and 20% silicate-based material by weight.

In accordance with an additional aspect of the disclosure, there is provided a glass container that includes an axially closed base at an axial end of the glass container, a body extending axially from the base and being circumferentially closed, an axially open mouth at another end of the glass container opposite of the base, and an exterior glass surface. The glass container also includes a sol-gel heat treated on at least a portion of the exterior glass surface of the glass container to form Si—O—Si bonds with the glass container to result in a coating having between 10% and 20% silicate-based material by weight.

In accordance with another aspect of the disclosure, there is provided a method of manufacturing a glass container including the steps of (a) forming a glass container; (b) annealing the glass container; (c) providing a solution having a composition including a silane, a solvent, a catalyst, and water; (d) applying the solution provided in step (c) to the exterior glass surface of the glass container, at a temperature between 40 and 60 degrees Celsius, such that the solution at least partially fills the surface imperfections; (e) heating the coated exterior glass surface of the glass container at a temperature between 180 degrees Celsius and 220 degrees Celsius to form a sol-gel from the solution; and (f) heating the coated exterior glass surface of the glass container at a temperature between 550 degrees Celsius and 700 degrees Celsius to form silica that forms Si—O—Si bonds with the exterior glass surface to result in a coating on the exterior glass surface having between 10% and 20% silicate-based material by weight to increase strength of the glass container.

### BRIEF DESCRIPTION OF THE DRAWINGS

The disclosure, together with additional objects, features, advantages and aspects thereof, will be best understood from the following description, the appended claims and the accompanying drawings, in which:

FIG. 1 is an elevational view of a glass container in accordance with an exemplary embodiment of the present disclosure;

FIG. 2 is a cross-sectional view of the glass container body before coating;

FIG. 3 is an enlarged sectional view of the glass container, taken from circle 3 of FIG. 1;

FIG. 3A is a sectional view of a glass container according to another embodiment;

FIG. 3B is a sectional view of a glass container according to a further embodiment;

FIG. 3C is a sectional view of a glass container according to an additional embodiment; and

FIG. 4 illustrates Weibull plots of baseline and coated glasses.

### DETAILED DESCRIPTION OF PREFERRED EMBODIMENTS

FIG. 1 illustrates an exemplary embodiment of a glass container 10 that may be produced in accord with an exemplary embodiment of a manufacturing process presently disclosed hereinbelow. The glass container 10 includes a longitudinal axis A, a base 10a at one axial end of the container 10 that is closed in an axial direction, a body 10b extending in an axial direction from the axially closed base 10a, and a mouth 10c at another axial end of the container 10 opposite of the base 10a. Accordingly, the glass container 10 is hollow. In the illustrated embodiment, the container 10 also includes a neck 10d that may extend axially from the body 10b, may be generally conical in shape, and may terminate in the mouth 10c. However, the container 10 need not include the neck 10d and the mouth 10c may terminate the body 10b, such as in a glass jar embodiment or the like. The body 10b may be of any suitable shape in cross-section transverse to the axis A as long as the body 10b is circumferentially closed.

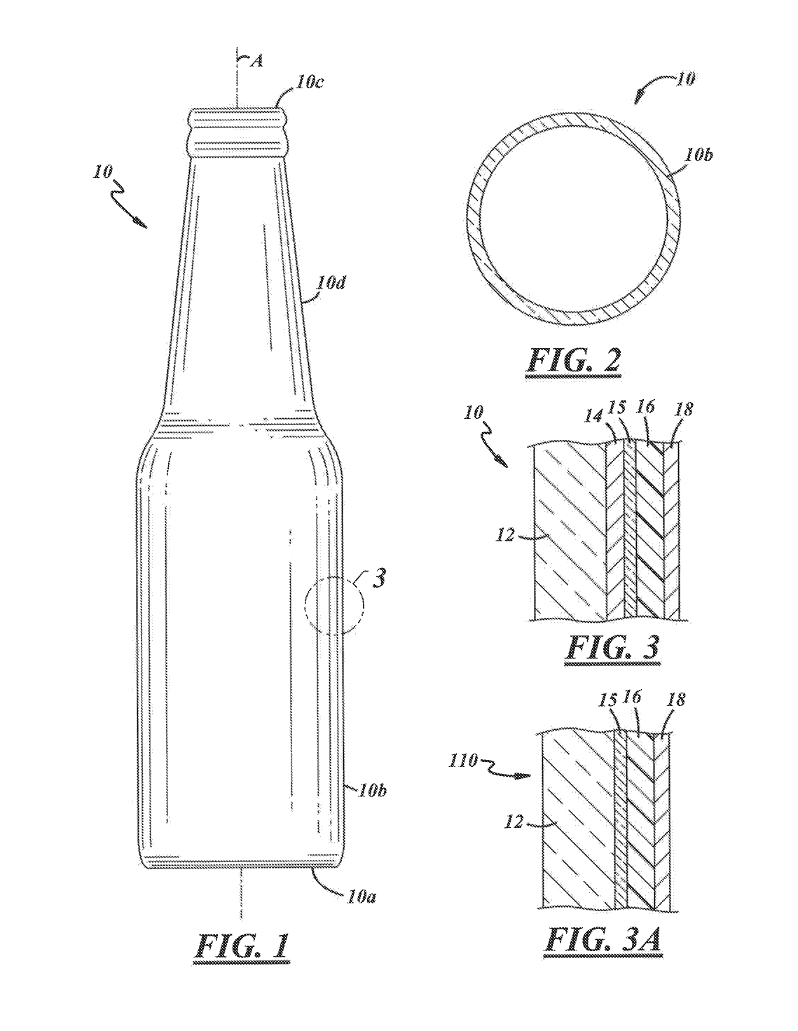

As shown in FIG. 2, for example, the body 10b may be of cylindrical transverse cross-sectional shape that is circumferentially closed. In other embodiments, the body 10b may be generally oval, square, rectangular, or of any other suitable transverse cross-sectional shape. As used herein, the term “circumferentially” applies not only to circular or cylindrical transverse cross-sectional shapes but also applies to any transverse cross-sectional shape.

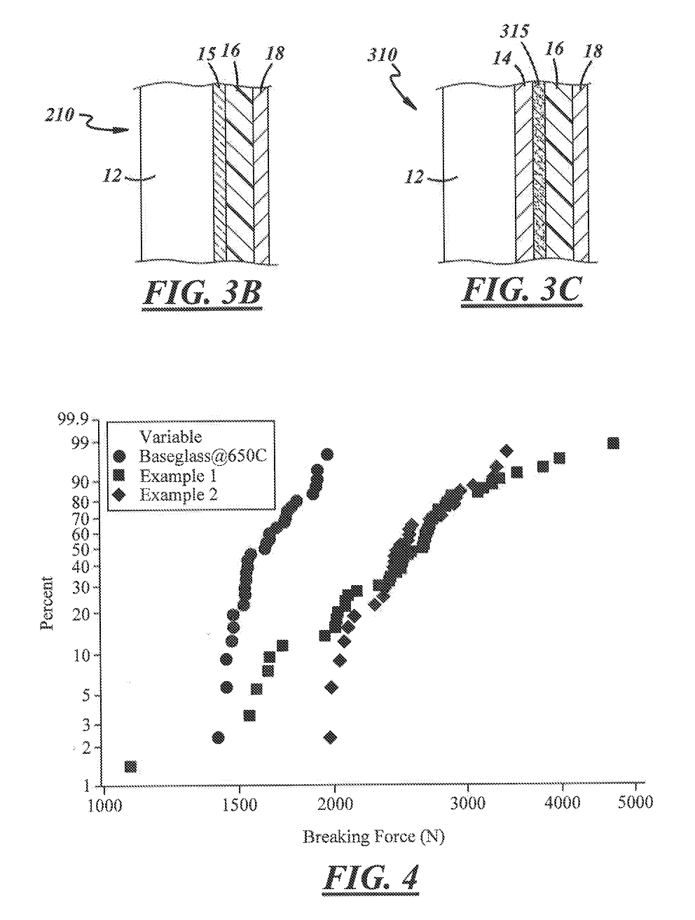

FIG. 3 illustrates that the container 10 includes a glass substrate 12, and further may include a hot-end coating 14 on an exterior glass surface of the container 10 on the substrate 12. The container 10 also includes a heat-treated sol-gel coating 15 on the exterior glass surface of the container 10. The coating 15 may be disposed on the hot-end coating 14 or directly on the substrate 12 itself. The container 10 further may include a cold-end coating 16 on the exterior glass surface of container 10 over the heat-treated sol-gel coating 15, and an organic coating 18 on the exterior glass surface of the container 10 over the cold-end coating 16. Although the various coatings 14-18 are shown as adjacent layers overlying one another sequentially, one or more of the coatings may penetrate into or even through one or more of the other coatings, and one or more of the coatings may be omitted. Accordingly, the various coatings 14-18 may be fairly described as being applied generally to the glass container 10, regardless of how or to what extent any given coating contacts any of the other coatings and/or the substrate 12. Similarly, when a material is described as being applied to an exterior glass surface of the glass container 10, the material may be applied over one or more of the coatings 14-18 and/or to the glass substrate 12 itself.

In some embodiments, the heat-treated sol-gel coating 15 may replace one or more of the other coatings. In one embodiment, the heat-treated sol-gel coating 15 may replace the hot-end coating 14. Therefore, the container 10 may be free of a conventional hot-end coating. In other words, the container 10 may be coated without a conventional hot-end coating. One example of a container 110 of the aforementioned embodiment is illustrated in FIG. 3A. In another embodiment, the heat-treated sol-gel coating 15 may replace the cold-end coating 16. Therefore, the container 10 may be free of a conventional cold-end coating. In other words, the container 10 may be coated without a conventional cold-end coating. One example of a container 210 of the aforementioned embodiment is illustrated in FIG. 3B.

The coating 15 is produced by using a sol-gel process that has the potential to increase the strength of glass containers by healing surface anomalies that may be present in the exterior surface of the container 10, and by preventing further creation of surface anomalies. For example, a solution may flow into a crack in glass and be retained therein as a sol-gel after heat-treating and be bonded thereto as silica after further heat treating, thereby bridging and blunting a crack tip to increase a burst strength of the container 10.

For purposes of the present disclosure, a sol-gel includes a material produced by any suitable sol-gel process. For example, a sol may be prepared including a solution of water, a solvent, and an alkoxide, and with or without a catalyst. The sol may undergo hydrolysis, and then condensation or sol gelation. The viscosity of the solution may be such that it flows well and may be sprayed at room temperatures onto containers and, then may be dried, cured, and/or heat treated at suitable temperatures. After heat-treatment, the presently disclosed coating 15 is rigid, scratch resistant, and transparent. Therefore, unlike many conventional surface-sealing coatings, the coating 15 looks and feels like glass. Moreover, the applied coating 15 may be relatively temperature stable and may survive severe temperature extremes, for example, from −20 degrees Celsius to 700 degrees Celsius.

The glass container 10 can be produced in any suitable manner. This typically would involve a “hot end” including one or more melting furnaces, forming machines, and beginning portions of annealing lehrs, and a “cold end” that may include end portions of annealing lehrs and includes inspection equipment and packaging machines. Accordingly, a hot-end coating is a coating applied at the hot end of the glass container manufacturing process, and a cold-end coating is a coating applied at the cold end of the glass container manufacturing process.

After forming a plurality of the glass container 10 with forming machines, but prior to annealing, the glass containers may be hot-end coated in any suitable manner with any suitable hot-end coating materials to produce the hot-end coating 14. For example, the glass containers may be hot-end coated with tin oxide, any other suitable metal oxide, or any other suitable material.

The glass containers then may be annealed in any suitable manner, for example, in an annealing lehr and, for instance, below 50 degrees Celsius. At an entry, hot end, or upstream portion of the annealing lehr, the temperature therein may be between 750 and 550 degrees Celsius. Through the lehr, the temperature may be brought down gradually to a downstream portion, cool end, or exit of the lehr, for example, to a temperature therein of between 130 degrees Celsius and 65 degrees Celsius, or even down to 40 degrees Celsius.

The solution is applied to the containers at any temperature suitable for such application. For example, the solution may be applied to the containers in a location downstream of an annealing lehr. In other words, the solution may be applied to the containers after annealing the containers. In another example, the solution may be applied to the containers at a downstream end of, and in, an annealing lehr that cools containers to 40 degrees Celsius.

Thereafter, the solution-coated containers are heat treated. For example, the coating 15 may be cured in one temperature range, and/or densified in a higher temperature range. The coated containers may be heat treated in an annealing lehr, for example, by looping the containers back through the annealing lehr, or by conveying the containers through a separate oven, lehr, and/or furnace downstream of the annealing lehr. In other embodiments, the coated containers may be heat treated in any suitable location in a glass container manufacturing process.

For instance, the containers may be heat treated at a temperature greater than 150 degrees Celsius and for a time suitable to flash or cure the solution into the sol-gel. In one embodiment, the containers may be heat treated at about 200 degrees Celsius for about five minutes. For example, the containers may be heat treated at a temperature between 180 and 220 degrees Celsius, including all subranges therebetween, and for a time between three and seven minutes, including all subranges therebetween. In a more specific example, the containers may be heat treated at a temperature between 190 and 210 degrees Celsius, including all subranges therebetween, and for a time between four and six minutes, including all subranges therebetween.

Also, or instead, the containers may be heat treated at a temperature greater than 500 degrees Celsius and for a time suitable to bond silica to the container glass. In one embodiment, the coated containers may be heat treated at about 600 degrees Celsius for about three and a half minutes. For example, the coated containers may be heat treated between 550 and 650 degrees Celsius, including all subranges therebetween, and for a time between two and five minutes, including all subranges therebetween. In a more specific example, the coated containers may be heat treated between 575 and 625 degrees Celsius, including all subranges therebetween, and for a time between three and four minutes, including all subranges therebetween. In another embodiment, the coated containers may be heat treated at about 650 degrees Celsius for about three and a half minutes. For example, the coated containers may be heat treated between 600 and 700 degrees Celsius, including all subranges therebetween, and for a time between two and five minutes, including all subranges therebetween. In a more specific example, the coated containers may be heat treated between 625 and 675 degrees Celsius, including all subranges therebetween, and for a time between three and four minutes, including all subranges therebetween.

A pre-sol-gel solution is provided for application to the containers to produce the coating 15. The solution may be purchased and shipped to a glass container manufacturing facility and/or may be prepared on site. Specific examples of solutions are described herein below. In general, however, the solution is composed of a silane, a solvent, a catalyst, and water. In one embodiment, the solution is a liquid-silicate-based material or silica matrix having a solids content of, for example, 10 to 50% by weight of silane.

The silane may be composed of one or more of the following silanes: tetraethoxysilane (TEOS), methyltriethoxysilane (MTES), 3-glycidoxypropyltrimethoxysilane (GPTMOS). The TEOS and MTES silanes may be obtained from Gelest, Inc. of Morrisville, Pa., or any other suitable source(s), and the GPTMOS may be obtained from Dow Chemical, of Midland, Mich. Other sources may include Aldrich and Nissan Chemical. In other embodiments, the silane may include one more of the following silanes: isobutyltrimethoxysilane, phenyltrimethoxysilane, octyltrimethoxysi lane, or aminopropyltriethoxysi lane. In general, the silane may include any suitable functional-based alkoxysilanes, for instance, acrylic, epoxy, amino, or carboxylic.

The solvent may include normal propanol. The solvents may be high purity solvents, and may be obtained from Fisher Scientific of Hampton, N.H., or any other suitable source(s). In other embodiments, the solvent may include one or more of the following solvents: denatured ethanol, anhydrous ethanol, methanol, isopropanol, butanol, diethylene glycol, acetones, methylethylketones, tryethyleneglycols, vinylpyrrolidones, toluene, glycerine, phenol, benzyl alcohol, or dioxane.

The catalyst may include an acid. For example, the acid may include acetic acid. In other embodiments, the acid may include hydrochloric acid, sulfuric acid, nitric acid, or the like.

In one embodiment, the silane may be about 14% of the pre-sol-gel solution by weight, and the solvent may be about 76% of the solution by weight, wherein the ratio of silane to solvent is about 1:5. For instance, the silane may be 12% to 18% of the solution by weight, and the solvent may be 72% to 78% of the solution by weight, wherein the ratio of silane to solvent is between 1:6 and 1:4.

In another embodiment, the silane may be about 48% of the pre-sol-gel solution by weight, and the solvent may be about 46% of the solution by weight, such that the weight ratio of silane to solvent may be about 1:1. For example, the silane may be 10% to 50% of the solution by weight, and the solvent may be 35% to 85% of the solution by weight, such that the weight ratio of silane to solvent may be between 1:9 and 1.5:1, including all subranges therebetween. In another example, the silane may be between 35% and 50% of the solution by weight, including all subranges therebetween, and the solvent may be between 45% and 60% of the solution by weight, including all subranges therebetween.

In a further embodiment, the solution may consist essentially of the silane, solvent, water, and catalyst materials.

In another embodiment, the solution also may include a colloidal silica in addition to matrix silica provided by the silane. For example, during production of a pre-sol-gel solution, a nanometer-sized colloidal silica may be added to the solution. In one embodiment, the colloidal silica may be about 3% of the solution by weight. For example, the colloidal silica may be 1% to 5% of the solution by weight. In a more specific example, the colloidal silica may be 2% to 4% of the solution by weight. The colloidal silica may include spherical particles, which may have sizes between 10 nm and 50 nm (and preferably less than 20 nm) for good filing of cracks. The colloidal silica may include silica dispersed in methyethylketone (MEK), for example, MEK-ST and MEK-ST-L available from Nissan Chemical America Corporation of Houston, Tex. FIG. 3C illustrates one example of a container 310 of the aforementioned embodiment including a colloidal sol-gel coating 315.

Also, the pre-sol-gel solution may be modified with other, additional materials. For example, the sol-gel may be doped with a dopant or doping material, for instance, an ultraviolet blocking material. In one embodiment, the ultraviolet blocking material may include one or more metal oxides. For example, the ultraviolet blocking material may include at least one of cerium oxide, titanium oxide, zinc oxide, bismuth oxide, or barium titanate. In another embodiment, the ultraviolet blocking material may include one or more metal alkoxides, for example, at least one of cerium alkoxide or titanium dialkoxide.

Accordingly, materials for providing strengthening and ultraviolet blocking properties may be applied in only one step. Accordingly, an ultraviolet blocking material need not be applied in a coating step separate from the pre-sol-gel coating step. As used herein, the phrase “ultraviolet blocking” includes reducing ultraviolet transparency and not necessarily resulting in 100% ultraviolet opacity. Accordingly, in this embodiment, the doped solution may include, and may consist essentially of, the silane, solvent, water, acid, and one or more of the doping materials or dopants. In one embodiment, the ultraviolet blocking material may be 0% to 10% of the solution by weight.

The exterior glass surface of the container is coated with the pre-sol-gel solution in any suitable manner. For example, the solution may be sprayed onto the exterior glass surface in any suitable manner. In other examples, the container may be dipped in the solution in any suitable manner, the solution may be wiped on the container, or the like.

In one embodiment, the solution is coated to the container at a temperature of about 50 degrees Celsius. For example, the solution may be coated to the container at a temperature of between 40 degrees Celsius and 60 degrees Celsius, including all subranges therebetween. In a more particular example, the solution may be coated to the container at a temperature between 45 degrees Celsius and 55 degrees Celsius, including all subranges therebetween.

The coated exterior glass surface of the container is heated or heat-treated for a time and at a temperature suitable to bond silica from the sol-gel to the container to result in the coating 15 having a sufficient amount of silicate-based material to increase strength of the container. In one embodiment, the temperature in the oven, lehr, or furnace is about 600 degrees Celsius and the silicate-based material is about 14% by weight. For example, the temperature in the oven, lehr, or furnace is between 550 degrees Celsius and 700 degrees Celsius, including all subranges therebetween, and the coating 15 may have between 10% and 20% silicate-based material by weight, including all subranges therebetween. In a more particular example, the temperature is between 575 degrees Celsius and 625 degrees Celsius, including all subranges therebetween, and the coating 15 may have between 12% to 16% silica-based material by weight, including all subranges therebetween.

The silicate-based material may bond to the glass container 10 in any suitable manner to produce Si—O—Si bonds. The bonds may be ionic or covalent, may be provided with any suitable bond angle(s), and the like. In one example, the bond length may be 1.618 to 1.623 Angstroms, and the bond angle may be 107 to 108 degrees.

After the glass containers are coated with the sol-gel and heat treated, they may be cold-end coated in any suitable manner. For example, the glass containers may be coated with the cold-end coating 16, which may be a protective organic coating applied downstream of the annealing lehr. The cold-end coating 16 may include a polyethylene material, like a polyethylene wax or the like, or may include any other suitable cold-end coating material.

After the cold-end coating is applied, the glass containers may be inspected for any suitable characteristics and in any suitable manner. For example, the glass containers may be manually or automatically inspected for cracks, inclusions, surface irregularities, hot end and/or cold-end coating properties, and/or the like.

The organic coating 18 may be applied to the glass containers in any suitable manner by any suitable equipment. For example, the organic coating 18 may be electrostatically applied to exterior glass surfaces of the glass containers, for example, after inspection.

After applying the organic coating, the glass containers may be cured in any suitable manner. For example, the curable organic coating may be a radiation-curable organic coating cured by any suitable type of radiation like, for instance, ultraviolet or electron beam radiation.

After curing, the glass containers may be packaged in any suitable manner.

The manufacturing process may or may not include all of the disclosed steps or be sequentially processed or processed in the particular sequence discussed, and the presently disclosed manufacturing process and coating methods encompass any sequencing, overlap, or parallel processing of such steps.

The present disclosure may provide one or more advancements in the art. For example, the heat-treated sol-gel coating can increase glass container strength by better healing of glass surface anomalies. In another example, the heat-treated sol-gel coating can increase glass container strength by retaining glass fragments, without using polyurethane or conventional additives. As used herein, the terminology fragment-retention is a characteristic well known to those of ordinary skill in the art of glass container manufacturing that relates to holding of glass fragments in the event that a glass container fractures or breaks, for example, from being dropped on hard ground.

Conventionally, it has been understood that some sol-gel materials can be uniformly applied to flat glass at temperatures below 500 degrees Celsius to achieve a thin and somewhat brittle coating to increase glass strength to some limited degree. But it was also understood that it was not cost-effective, or was impossible, to uniformly apply the same sol-gel materials in solid and continuous films over exterior surfaces of glass containers to achieve reliable glass strengthening results. Contrary to conventional wisdom, it is now possible and cost-effective to produce glass containers having a sol-gel coating having relatively uniform coverage to achieve a relatively thicker and stronger coating to increase glass strength to a greater degree.

It has also been conventionally understood that fragment retention coatings for glass containers are composed of a polyurethane base formed from an isocyanate monomer or prepolymers of isocyanates, and additives like bisphenol A, melamine, benzoguanamine, and the like to enable room temperature curing. But isocyanates and such additives tend to be cost-prohibitive and undesirable. Contrary to conventional wisdom, it is now possible to produce glass containers with an isocyanate-free and amine-group-free fragment retention coating that is cost-effective and desirable.

Therefore, the presently disclosed method provides simple but elegant solutions to problems in the art of glass container manufacturing that have long been experienced but apparently unappreciated.

### EXAMPLES

Below, and with reference to Table 1, several examples of pre-sol-gel solutions and their preparation are provided and explained, as well as a coating technique and performance results.

TABLE 1

| | | | | | | | | Crack |
|---|---|---|---|---|---|---|---|---|
| Ex. | Silica System | | | | Solvent | Acid | Water | Filling |
| # | Matrix | (gm) | Colloidal | (gm) | (gm) | (gm) | (gm) | (0-5) |
| 1 | TEOS | 13.87 | n/a | n/a | 79.32 | 2.01 | 4.79 | 0 |
| 2 | TEOS | 27.74 | n/a | n/a | 65.45 | 2.01 | 4.79 | 1 |
| 3 | TEOS | 41.61 | n/a | n/a | 51.58 | 2.01 | 4.79 | 2 |
| 4 | TEOS | 55.48 | n/a | n/a | 37.71 | 2.01 | 4.79 | 2 |
| 5 | MTES | 23.74 | n/a | n/a | 69.45 | 2.01 | 4.79 | 1 |
| 6 | MTES | 35.61 | n/a | n/a | 57.58 | 2.01 | 4.79 | 2 |
| 7 | MTES | 47.49 | n/a | n/a | 45.7 | 2.01 | 4.79 | 3 |
| 8 | GPTMOS | 11.87 | n/a | n/a | 82.30 | 2.01 | 4.79 | 1 |
| 9 | GPTMOS | 23.74 | n/a | n/a | 69.45 | 2.01 | 4.79 | 2 |
| 10 | GPTMOS | 35.61 | n/a | n/a | 57.58 | 2.01 | 4.79 | 3 |
| 11 | GPTMOS | 47.7 | n/a | n/a | 45.7 | 2.01 | 4.79 | 3 |
| 12 | TEOS | 20.81 | n/a | n/a | 25.79 | 1.01 | 2.40 | 1 |
| 13 | TEOS | 19.76 | MEK-ST 5 wt % | 1 | 25.84 | 1.01 | 2.40 | 1 |
| 14 | TEOS | 19.24 | MEK-ST 7.5 wt % | 1.5 | 25.86 | 1.01 | 2.40 | 1 |
| 15 | TEOS | 18.72 | MEK-ST 10 wt % | 2 | 25.88 | 1.01 | 2.40 | 2 |
| 16 | TEOS | 19.76 | MEK-ST-L 5 wt % | 1 | 25.84 | 1.01 | 2.40 | 1 |
| 17 | TEOS | 19.24 | MEK-ST-L 7.5 wt % | 1.5 | 25.86 | 1.01 | 2.40 | 2 |
| 18 | GPTMOS | 23.57 | n/a | n/a | 23.03 | 1.01 | 2.40 | 1 |
| 19 | GPTMOS | 22.39 | MEK-ST 5 wt % | 1 | 23.21 | 1.01 | 2.40 | 1 |
| 20 | GPTMOS | 21.80 | MEK-ST 7.5 wt % | 1.5 | 23.30 | 1.01 | 2.40 | 1 |
| 21 | GPTMOS | 21.21 | MEK-ST 10 wt % | 2 | 23.39 | 1.01 | 2.40 | 2 |
| 22 | GPTMOS | 22.39 | MEK-ST-L 5 wt % | 1 | 23.21 | 1.01 | 2.40 | 2 |
| 23* | GPTMOS | 15.7 | n/a | n/a | 30.9 | 2 | 2.4 | n/a |
| 24 | GPTMOS | 7.07 | MEK-ST_1.32% | 0.66 | 37.87 | 2 | 2.4 | n/a |

### Example #1

Solution Preparation

A solution was prepared using 13.87 gm of tetraethoxysilane, 79.32 gm of normal propanol, 2.01 gm of acetic acid, and 4.79 gm of water. The solution was mixed for forty-eight hours.

Coating Formation

Glass substrates of 2″ by 2″ size were cleaned by soap and water. The glass substrates were then wiped by isopropanol and dried well.

On a first sample of the glass substrates, a crack was formed on the glass substrate using a Vickers hardness instrument at 25 gf for 30 sec. The glass substrate was coated with the solution using a spin coater at 1000 RPM for 30 seconds using 500 RPM as a ramping speed. The coated glass substrate was gradually heated according to a three step heating sequence; first on a hot plate for one minute at 150 degrees Celsius, and then in an oven at 200 degrees Celsius for five minutes, and then in a furnace at 600 degrees Celsius for 3.5 minutes.

Performance After Curing

On the first sample, the coating was analyzed by optical microscopy to analyze the healing effect on the crack, using a scale of 0 to 5, wherein 0 indicates no crack filling and 5 indicates complete crack filling. Micrographs of the crack were taken before and after the coatings and indicated that the crack was not filled by the coating due to the low solid content in the formulation, resulting in a “0” on the 0-5 scale.

### Example #2

Example #2 was similar to example #1 in solution preparation and coating formation, except the amounts of tetraethoxysilane and normal propanol were 27.74 gm and 65.45 gm, respectively.

On a second cracked and coated glass sample, micrographs of the crack were taken before and after the coating and indicated that the crack was at least partially filled by the coating, resulting in a “1” on the 0-5 scale.

### Example #3

Example #3 was similar to example #1 in solution preparation and coating formation, except the amounts of tetraethoxysilane and normal propanol were 41.61 gm and 51.58 gm, respectively.

On a third cracked and coated glass sample, micrographs of the crack were taken before and after the coating and indicated that the crack was at least partially filled by the coating, resulting in a “2” on the 0-5 scale.

### Example #4

Example #4 was similar to example #1 in solution preparation and coating formation, except the amounts of tetraethoxysilane and normal propanol were 55.48 gm and 37.71 gm, respectively.

On a fourth cracked and coated glass sample, micrographs of the crack were taken before and after the coating and indicated that the crack was at least partially filled by the coating, resulting in a “2” on the 0-5 scale.

### Example #5

Example #5 was similar to example #1 in solution preparation and coating formation, except the silica system used included 23.74 gm of methyltriethoxysilane instead of tetraethoxysilane and the amount of normal propanol was 69.45 gm.

On a fifth cracked and coated glass sample, micrographs of the crack were taken before and after the coating and indicated that the crack was at least partially filled by the coating, resulting in a “1” on the 0-5 scale.

### Example #6

Example #6 was similar to example #1 in solution preparation and coating formation, except the silica system used included 35.61 gm of methyltriethoxysilane instead of tetraethoxysilane and the amount of normal propanol was 57.58 gm.

On a sixth cracked and coated glass sample, micrographs of the crack were taken before and after the coating and indicated that the crack was at least partially filled by the coating, resulting in a “2” on the 0-5 scale.

### Example #7

Example #7 was similar to example #1 in solution preparation and coating formation, except the silica system used included 47.49 gm of methyltriethoxysilane instead of tetraethoxysilane and the amount of normal propanol was 45.7 gm.

On a seventh cracked and coated glass sample, micrographs of the crack were taken before and after the coating respectively, and indicated that the crack was at least partially filled by the coating, resulting in a “3” on the 0-5 scale.

### Example #8

Example #8 was similar to example #1 in solution preparation and coating formation, except the silica system used included 11.87 gm of 3-glycidoxypropyltrimethoxysilane instead of tetraethoxysilane and the amount of normal propanol was 82.30 gm.

On an eighth cracked and coated glass sample, micrographs of the crack were taken before and after the coating respectively, and indicated that the crack was at least partially filled by the coating, resulting in a “1” on the 0-5 scale.

### Example #9

Example #9 was similar to example #1 in solution preparation and coating formation, except the silica system used included 23.74 gm of 3-glycidoxypropyltrimethoxysilane instead of tetraethoxysilane and the amount of normal propanol was 69.45 gm.

On an ninth cracked and coated glass sample, micrographs of the crack were taken before and after the coating respectively, and indicated that the crack was at least partially filled by the coating, resulting in a “2” on the 0-5 scale.

### Example #10

Example #10 was similar to example #1 in solution preparation and coating formation, except the silica system used included 35.61 gm of 3-glycidoxypropyltrimethoxysilane instead of tetraethoxysilane and the amount of normal propanol was 57.58 gm.

On a tenth cracked and coated glass sample, micrographs of the crack were taken before and after the coating respectively, and indicated that the crack was at least partially filled by the coating, resulting in a “3” on the 0-5 scale.

### Example #11

Example #11 was similar to example #1 in solution preparation and coating formation, except the silica system used included 47.7 gm of 3-glycidoxypropyltrimethoxysilane instead of tetraethoxysilane and the amount of normal propanol was 45.7 gm.

On an eleventh cracked and coated glass sample, micrographs of the crack were taken before and after the coating respectively, and indicated that the crack was at least partially filled by the coating, resulting in a “3” on the 0-5 scale.

### Example #12

A solution was prepared using 20.81 gm of tetraethoxysilane, 25.79 gm of normal propanol, 1.01 gm of acetic acid, and 2.40 gm of water. The solution was mixed for forty-eight hours. The coating formation and crack analysis are the same as with Example #1.

On a twelfth cracked and coated glass sample, micrographs of the crack were taken before and after the coating respectively, and indicated that the crack was at least partially filled by the coating, resulting in a “1” on the 0-5 scale.

The solution is similar to that of Example #3 but with a different concentration.

### Example #13

A matrix silica solution was prepared using 19.76 gm of tetraethoxysilane, 25.84 gm of normal propanol, 1.01 gm of acetic acid, and 2.40 gm of water. The solution was mixed for three hours, and then 1 gm of a MET-ST colloidal silica was added to the matrix silica solution and mixed for another forty-eight hours. The coating formation and crack analysis are the same as with Example #1.

On a thirteenth cracked and coated glass sample, micrographs of the crack were taken before and after the coating respectively, and indicated that the crack was at least partially filled by the coating, resulting in a “1” on the 0-5 scale.

### Example #14

A matrix silica solution was prepared using 19.24 gm of tetraethoxysilane, 25.86 gm of normal propanol, 1.01 gm of acetic acid, and 2.40 gm of water. The solution was mixed for three hours, and then 1.5 gm of a MET-ST colloidal silica was added to the matrix silica solution and mixed for another forty-eight hours. The coating formation and crack analysis are the same as with Example #1.

On a fourteenth cracked and coated glass sample, micrographs of the crack were taken before and after the coating respectively, and indicated that the crack was at least partially filled by the coating, resulting in a “2” on the 0-5 scale.

### Example #15

A matrix silica solution was prepared using 18.72 gm of tetraethoxysilane, 25.88 gm of normal propanol, 1.01 gm of acetic acid, and 2.40 gm of water. The solution was mixed for three hours, and then 2 gm of a MET-ST colloidal silica was added to the matrix silica solution and mixed for another forty-eight hours. The coating formation and crack analysis are the same as with Example #1.

On a fifteenth cracked and coated glass sample, micrographs of the crack were taken before and after the coating respectively, and indicated that the crack was at least partially filled by the coating, resulting in a “2” on the 0-5 scale.

### Example #16

A matrix silica solution was prepared using 19.76 gm of tetraethoxysilane, 25.84 gm of normal propanol, 1.01 gm of acetic acid, and 2.40 gm of water. The solution was mixed for three hours, and then 1 gm of a MET-ST-L colloidal silica was added to the matrix silica solution and mixed for another forty-eight hours. The coating formation and crack analysis are the same as with Example #1.

On a sixteenth cracked and coated glass sample, micrographs of the crack were taken before and after the coating respectively, and indicated that the crack was at least partially filled by the coating, resulting in a “1” on the 0-5 scale.

### Example #17

A matrix silica solution was prepared using 19.24 gm of tetraethoxysilane, 25.86 gm of normal propanol, 1.01 gm of acetic acid, and 2.40 gm of water. The solution was mixed for three hours, and then 1.5 gm of a MET-ST-L colloidal silica was added to the matrix silica solution and mixed for another forty-eight hours. The coating formation and crack analysis are the same as with Example #1.

On a seventeenth cracked and coated glass sample, micrographs of the crack were taken before and after the coating respectively, and indicated that the crack was at least partially filled by the coating, resulting in a “2” on the 0-5 scale.

### Example #18

A matrix silica solution was prepared using 23.57 gm of 3-glycidoxypropyltrimethoxysilane, 23.03 gm of normal propanol, 1.01 gm of acetic acid, and 2.40 gm of water. The solution was mixed for forty-eight hours. The coating formation and crack analysis are the same as with Example #1.

On an eighteenth cracked and coated glass sample, micrographs of the crack were taken before and after the coating respectively, and indicated that the crack was at least partially filled by the coating, resulting in a “1” on the 0-5 scale.

The solution is similar to that of Example #11 but with a different concentration.

### Example #19

A matrix silica solution was prepared using 22.39 gm of 3-glycidoxypropyltrimethoxysilane, 23.21 gm of normal propanol, 1.01 gm of acetic acid, and 2.40 gm of water. The solution was mixed for three hours, and then 1 gm of a MET-ST colloidal silica was added to the matrix silica solution and mixed for another forty-eight hours. The coating formation and crack analysis are the same as with Example #1.

On a nineteenth cracked and coated glass sample, micrographs of the crack were taken before and after the coating respectively, and indicated that the crack was at least partially filled by the coating, resulting in a “1” on the 0-5 scale.

### Example #20

A matrix silica solution was prepared using 21.80 gm of 3-glycidoxypropyltrimethoxysilane, 23.30 gm of normal propanol, 1.01 gm of acetic acid, and 2.40 gm of water. The solution was mixed for three hours, and then 1.5 gm of a MET-ST colloidal silica was added to the matrix silica solution and mixed for another forty-eight hours. The coating formation and crack analysis are the same as with Example #1.

On a twentieth cracked and coated glass sample, micrographs of the crack were taken before and after the coating respectively, and indicated that the crack was at least partially filled by the coating, resulting in a “1” on the 0-5 scale.

### Example #21

A matrix silica solution was prepared using 21.21 gm of 3-glycidoxypropyltrimethoxysilane, 23.39 gm of normal propanol, 1.01 gm of acetic acid, and 2.40 gm of water. The solution was mixed for three hours, and then 2 gm of a MET-ST colloidal silica was added to the matrix silica solution and mixed for another forty-eight hours. The coating formation and crack analysis are the same as with Example #1.

On a twenty-first cracked and coated glass sample, micrographs of the crack were taken before and after the coating respectively, and indicated that the crack was at least partially filled by the coating, resulting in a “2” on the 0-5 scale.

### Example #22

A matrix silica solution was prepared using 22.39 gm of 3-glycidoxypropyltrimethoxysilane, 23.21 gm of normal propanol, 1.01 gm of acetic acid, and 2.40 gm of water. The solution was mixed for three hours, and then 1 gm of a MET-ST-L colloidal silica was added to the matrix silica solution and mixed for another forty-eight hours. The coating formation and crack analysis are the same as with Example #1.

On a nineteenth cracked and coated glass sample, micrographs of the crack were taken before and after the coating respectively, and indicated that the crack was at least partially filled by the coating, resulting in a “2” on the 0-5 scale.

### Example #23

### Comparative

Solution Preparation

A solution was prepared using 15.7 gm of 3-glycidoxypropyltrimethoxysilane, 30.9 gm of normal propanol, 2 gm of acetic acid, and 2.40 gm of water. The solution was mixed for forty-eight hours.

Coating Formation

Glass substrates of 2″ by 2″ size were cleaned by soap and water. The glass substrates were then wiped by isopropanol and dried well.

On a first sample of the glass substrates, a crack was formed on the glass substrate using a Vickers hardness instrument at 200 gf for 30 sec. The glass substrate was coated with the solution using a spin coater at 1000 RPM for 30 seconds using 500 RPM as a ramping speed. The coated glass substrate was gradually heated according to a three step heating sequence; first on a hot plate for one minute at 150 degrees Celsius, and then in an oven at 200 degrees Celsius for five minutes, and then in a furnace at 650 degrees Celsius for 3.5 minutes.

Performance After Curing

FIG. 4 illustrates Weibull plots of glass strength for a baseline glass that is uncoated with the coating, and a glass coated in accordance with Example #23. The baseline glass is the same as the coated glass, except no coating is applied. The plots for the baseline glass and the glass coated in accordance with Example #23 share a low end or tail.

### Example #24

A matrix silica solution was prepared using 7.07 gm of 3-glycidoxypropyltrimethoxysilane, 37.87 gm of normal propanol, 2 gm of acetic acid, and 2.40 gm of water. The solution was mixed for three hours, and then 0.66 gm of a MET-ST colloidal silica was added to the matrix silica solution and mixed for another forty-eight hours. The coating formation and crack analysis are the same as with Example #23. The size of the colloidal silica may be less than 20 nm and spherical.

FIG. 4 illustrates Weibull plots of glass strength for a baseline glass that is uncoated with the coating, and a glass coated in accordance with Example #24. The baseline glass is the same as the coated glass, except no coating is applied. The plot for the glass coated in accordance with Example #24 does not share a low end or tail with the plot for the baseline glass.

There thus has been disclosed methods of coating glass containers and methods of manufacturing glass containers that at least partially satisfy one or more of the objects and aims previously set forth. The disclosure has been presented in conjunction with several exemplary embodiments, and additional modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A method of filling surface imperfections in an exterior glass surface of a glass container that includes the steps of:
(a) providing a solution having a composition including a silane, a solvent, a catalyst, and water;
(b) applying the solution provided in step (a) to the exterior glass surface of the glass container, at a temperature between 40 and 60 degrees Celsius, such that the solution at least partially fills the surface imperfections; and then
(c) heating the glass container at a temperature greater than 500 degrees Celsius to produce Si—O—Si bonds with the exterior glass surface of the glass container to result in a coating having between 10% and 20% silicate-based material by weight.

2. The method set forth in claim 1 wherein the composition in step (a) includes between 10% and 60% by weight of the silane and between 35% and 80% by weight of the solvent, the temperature in step (b) is between 45 degrees Celsius and 55 degrees Celsius, and the heating step (c) is carried out at a temperature between 550 and 700 degrees Celsius and for a time between two and five minutes.

3. The method set forth in claim 2 including, before the heating step (c), heating the glass container at a temperature between 180 and 220 degrees Celsius for a time between three and seven minutes such that the solution applied in step (b) forms a sol-gel.

4. The method set forth in claim 1 wherein the composition in step (a) includes between 11.87% and 55.48% by weight of at least one silane and between 82.30% and 37.71% by weight of at least one solvent, the temperature in step (b) is between 45 degrees Celsius and 55 degrees Celsius, and the heating step (c) is carried out at a temperature of between 625 and 675 degrees Celsius and for a time between two and four minutes.

5. The method set forth in claim 4 including, before the heating step (c), heating the glass container at a temperature between 190 and 210 degrees Celsius for a time between four and six minutes such that the solution applied in step (b) forms a sol-gel.

6. The method set forth in claim 1 wherein the composition in step (a) includes about 34% by weight of at least one silane and about 60% by weight of at least one solvent, the temperature in step (b) is about 50 degrees Celsius, and the heating step (c) is carried out at a temperature of about 650 degrees Celsius and for a time of about three and a half minutes.

7. The method set forth in claim 6 including, before the heating step (c), heating the glass container at a temperature of about 200 degrees Celsius for a time of about five minutes such that the solution applied in step (b) forms a sol-gel.

8. The method set forth in claim 1 wherein the silane in step (a) includes tetraethoxysilane, methyltriethoxysilane, or 3-glycidoxypropyltrimethoxysilane, and wherein the solvent in step (a) includes denatured ethanol, anhydrous ethanol, methanol, normal propanol, isopropanol, butanol, diethylene glycol, acetones, methylethylketones, tryethyleneglycols, vinylpyrrolidones, toluene, glycerine, phenol, benzyl alcohol, or dioxane.

9. The method set forth in claim 1 wherein the silane in step (a) includes 3-glycidoxypropyltrimethoxysilane, and wherein the solvent includes normal propanol.

10. The method set forth in claim 1 wherein the composition in step (a) includes a silane to solvent weight ratio of between 1:10 and 1.5:1.

11. The method set forth in claim 1 wherein the composition in step (a) includes a silane to solvent weight ratio of about 1:5.

12. The method set forth in claim 1 wherein the solution is doped with an ultraviolet blocking material, wherein the ultraviolet blocking material is not applied in a separate step.

13. The method set forth in claim 12 wherein the ultraviolet blocking material is at least one of cerium oxide, titanium oxide, zinc oxide, bismuth oxide, or barium titanate.

14. The method set forth in claim 1 wherein the solution is doped with at least one metal alkoxide that is not applied in a separate step.

15. The method set forth in claim 14 wherein the at least one metal alkoxide is at least one of cerium alkoxide or titanium dialkoxide.

16. The method set forth in claim 1 wherein the composition of the solution includes a silica matrix and a colloidal silica.

17. The method set forth in claim 16 wherein the colloidal silica includes spherical nanoparticles less than 20 nm in size.

18. The method set forth in claim 16 wherein the colloidal silica includes silica dispersed in methylethylkeytone.

19. The method set forth in claim 16 wherein the composition in step (a) includes between 12% and 18% by weight of the silane and between 1% and 5% weight of the colloidal silica.

20. A glass container made by the method set forth in claim 1.

21. A glass container that includes:
an axially closed base at an axial end of the glass container;
a body extending axially from the base and being circumferentially closed;
an axially open mouth at another end of the glass container opposite of the base;
an exterior glass surface; and
a sol-gel heat-treated on at least a portion of the exterior glass surface of the glass container to form Si—O—Si bonds with the glass container to result in a coating having between 10% and 20% silicate-based material by weight.

22. The glass container set forth in claim 21 wherein the coating includes an ultraviolet blocking material.

23. The glass container set forth in claim 22 wherein the ultraviolet blocking material includes at least one of cerium, titanium, zinc, bismuth, or barium titanate.

24. The glass container set forth in claim 21 wherein the composition of the coating includes a silica matrix and a colloidal silica.

25. The glass container set forth in claim 24 wherein the colloidal silica includes spherical nanoparticles less than 20 nm in size.

26. The glass container set forth in claim 24 wherein the colloidal silica includes silica dispersed in methylethylkeytone.

27. The glass container set forth in claim 21, having no hot-end coating, other than the sol-gel coating.

28. The glass container set forth in claim 21, having no cold-end coating, other than the sol-gel coating.

29. A method of manufacturing that includes the steps of:
(a) forming a glass container;
(b) annealing the glass container;
(c) providing a solution having a composition including a silane, a solvent, a catalyst, and water;
(d) applying the solution provided in step (c) to the exterior glass surface of the glass container, at a temperature between 40 and 60 degrees Celsius, such that the solution at least partially fills the surface imperfections;
(e) heating the exterior glass surface of the glass container at a temperature between 180 degrees Celsius and 220 degrees Celsius to form a sol-gel; and
(f) further heating the exterior glass surface of the glass container at a temperature between 550 degrees Celsius and 700 degrees Celsius to form silica that forms Si—O—Si bonds with the exterior glass surface to result in a coating on the exterior glass surface having between 10% and 20% silicate-based material by weight to increase strength of the glass container.

30. The method set forth in claim 29 also including applying a cold-end coating to the exterior glass surface of the glass container, but not applying a hot-end coating to the exterior glass surface of the glass container other than the sol-gel coating.

31. The method set forth in claim 29 also including applying a hot-end coating to the exterior glass surface of the glass container, but not applying a cold-end coating to the exterior glass surface of the glass container other than the sol-gel coating.

32. The method set forth in claim 29 wherein the silane in step (c) includes tetraethoxysilane, methyltriethoxysilane, or 3-glycidoxypropyltrimethoxysilane, and wherein the solvent in step (c) includes denatured ethanol, anhydrous ethanol, methanol, normal propanol, isopropanol, butanol, diethylene glycol, acetones, methylethylketones, tryethyleneglycols, vinylpyrrolidones, toluene, glycerine, phenol, benzyl alcohol, or dioxane.

33. The method set forth in claim 29 wherein the composition in step (c) includes a silane to solvent weight ratio of about 1:5.

34. The method set forth in claim 29 wherein the solution is doped with an ultraviolet blocking material, wherein the ultraviolet blocking material is not applied in a separate step.

35. The method set forth in claim 29 wherein the composition of the solution includes a silica matrix and a colloidal silica.

36. The method set forth in claim 35 wherein the colloidal silica includes spherical nanoparticles less than 20 nm in size, and wherein the colloidal silica includes silica dispersed in methylethylkeytone.
